(19) United States
(12) Patent Application Publication
(10) Pub. No.: US 2023/0043112 A1
(43) Pub. Date: Feb. 9, 2023

(54) LIMITING STRUCTURE OF BICYCLE

(71) Applicant: Shenzhen COOGHI Funkids Technology Co., Ltd, Shenzhen (CN)

(72) Inventor: Jun Zhang, Shenzhen (CN)

(21) Appl. No.: 17/867,703

(22) Filed: Jul. 19, 2022

(30) Foreign Application Priority Data
Aug. 6, 2021 (CN) 202121837389.7

(51) Int. Cl. B62K 21/08; B62K 21/18; B62K 9/00

(52) U.S. Cl. CPC B62K 21/08; B62K 21/18; B62K 9/00

(57) ABSTRACT

A limiting structure of a bicycle includes a handlebar, a rotating member, a front fork, and a frame. The frame is provided with a mounting portion. The handlebar is partially accommodated at one end of the mounting portion, and the front fork is partially accommodated at the other end of the mounting portion. The rotating member is accommodated in the mounting portion. Two ends of the rotating member are movably connected to the front fork and the handlebar, respectively. An annular movable groove is formed between an inner wall of the mounting portion and the rotating member. The front fork is provided with a first limiting block, and the first limiting block is movably accommodated in the movable groove. The frame further includes a second limiting block, and the second limiting block is fixedly accommodated in the movable groove.

### CROSS REFERENCE TO RELATED APPLICATIONS

This application claims priority to Chinese patent application No. 202121837389.7, filed on Aug. 6, 2021. The contents of the above identified applications are hereby incorporated herein in their entireties by reference.

### BACKGROUND

### 1. Technical Field

The present disclosure relates to the technical field of bicycle parts, and particular to a limiting structure of a bicycle.

### 2. Description of Related Art

Most of the children's bicycles on the current market have a 360-degree free turning. Because the free turning angle is too large, children, especially children at the beginning stage, are prone to lose their balance and fall down when riding a bicycle. Even if auxiliary wheels are additionally mounted, the turning angle is too large and the inertia of the bicycle during driving will easily cause the bicycle to lose balance and then fall down. Therefore, the turning mechanism on the current children's bicycle has no limitation on turning due to the lack of a limiting mechanism, and there are potential safety hazards for children during the riding process.

### BRIEF DESCRIPTION OF THE DRAWINGS

In order to more clearly illustrate the technical solutions in this embodiment disclosure, the drawings used in the embodiments or the description of the prior art will be briefly introduced below. It should be understood that, the drawings in the following description are only examples of the present disclosure. For those skilled in the art, other drawings can be obtained based on these drawings without creative works.

FIG. 1 is a perspective view of a limiting structure of a bicycle according to the present disclosure.

FIG. 2 is a perspective view of a rotating member according to the present disclosure.

FIG. 3 is a perspective view of a front fork according to the present disclosure.

FIG. 4 is a cross-sectional view of a limiting structure of a bicycle according to the present disclosure.

FIG. 5 is a partially enlarged schematic view of portion A in FIG. 4.

FIG. 6 is a cross-sectional view of a partial structure of the limiting structure of the bicycle according to the present disclosure.

FIG. 7 is a cross-sectional view of an adjusting member according to the present disclosure.

### DETAILED DESCRIPTION

In order to make the objectives, technical solutions, and advantages of the present disclosure clearer, the present disclosure will be further described in detail below with reference to the drawings and embodiments. It should be understood that, the embodiments described herein are only for explaining the present disclosure and are not intended to limit the present disclosure.

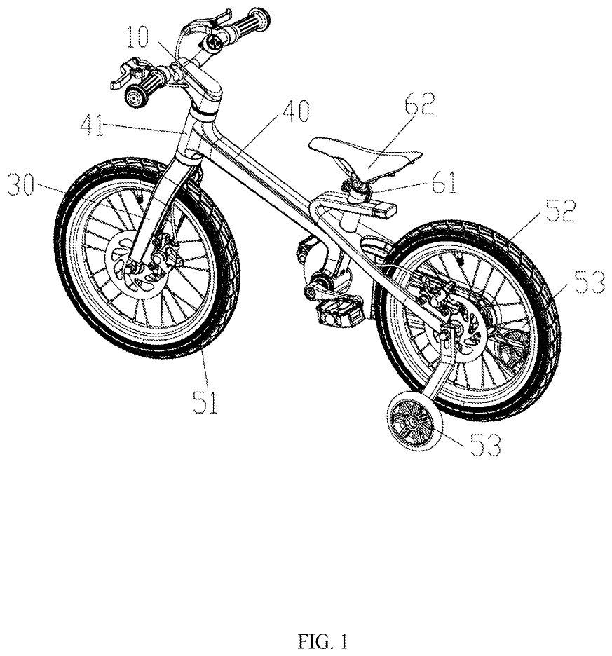

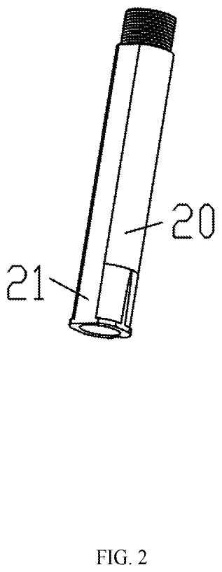

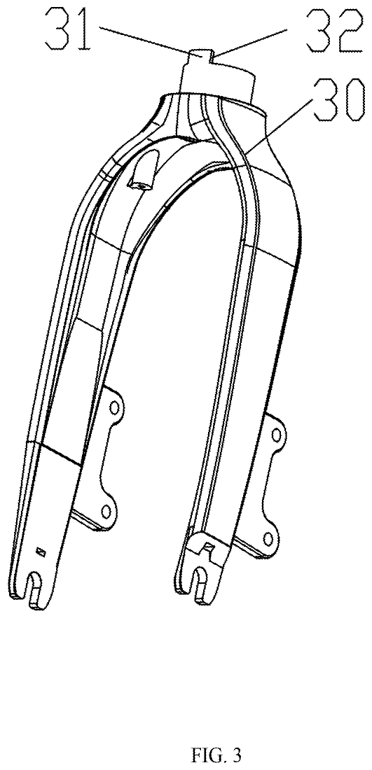

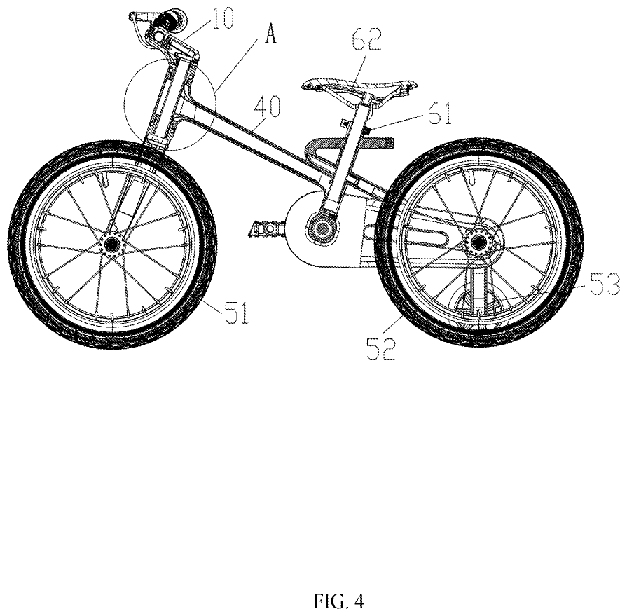

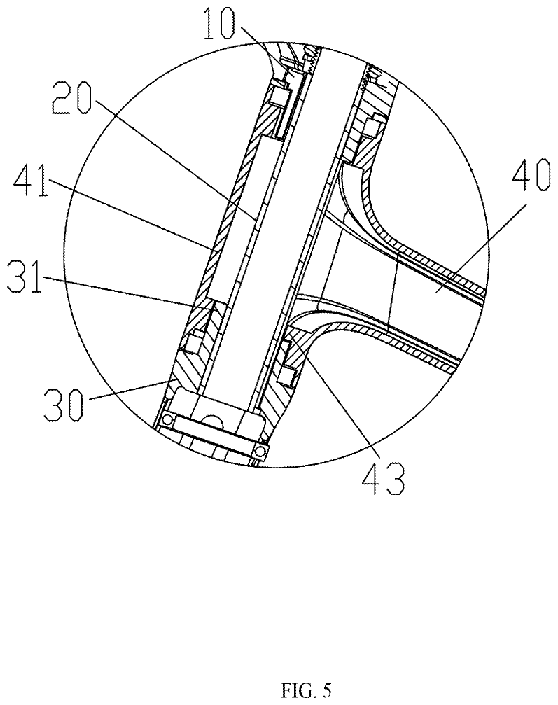

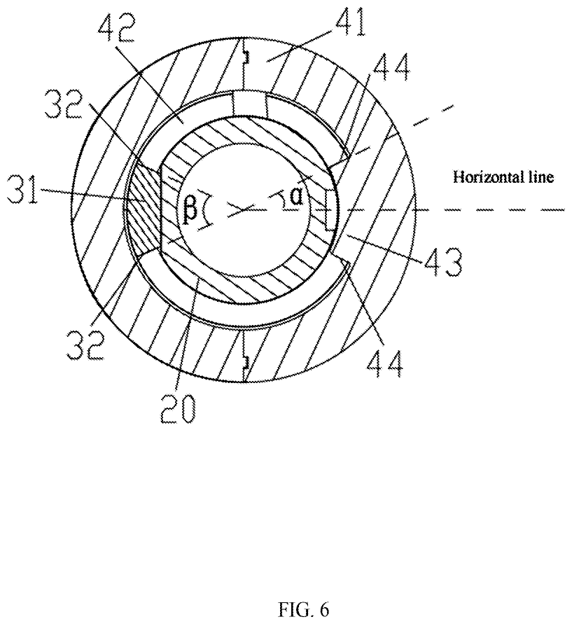

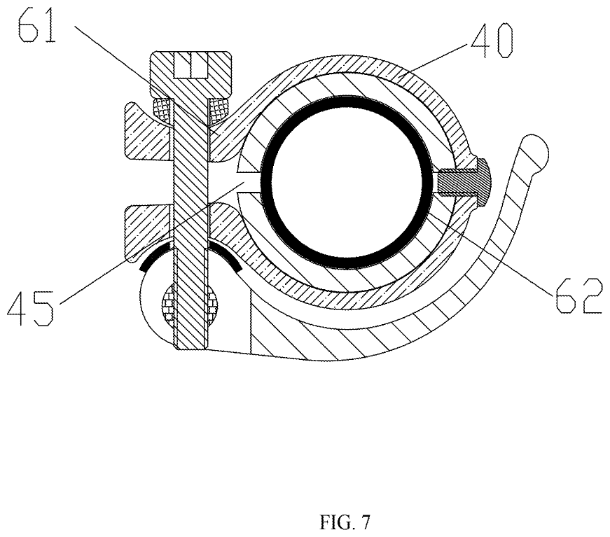

Referring to FIG. 1 to FIG. 7, the present disclosure provides a limiting structure of a bicycle, which includes: a handlebar 10, a rotating member 20, a front fork 30, and a frame 40. The frame 40 is provided with a mounting portion 41. The handlebar 10 is partially accommodated at one end of the mounting portion 41, and the front fork 30 is partially accommodated at the other end of the mounting portion 41. The rotating member 20 is accommodated in the mounting portion 41. Two ends of the rotating member 20 are movably connected to the front fork 30 and the handlebar 10, respectively. An annular movable groove 42 is formed between an inner wall of the mounting portion 41 and the rotating member 20. The front fork 30 is provided with a first limiting block 31, and the first limiting block 31 is movably accommodated in the movable groove 42. The frame 40 further includes a second limiting block 43, and the second limiting block 43 is fixedly accommodated in the movable groove 42.

In the present embodiment, during use, since the first limiting block 31 is movably accommodated in the movable groove 42, the second limiting block 43 is fixedly accommodated in the movable groove 42. When the handlebar 10 is rotated, the handlebar 10 drives the front fork 30 to rotate by the rotating member 20, so that the first limiting block 31 rotates around the center of the rotating member 20 in the movable groove 42. When the first limiting block 31 is abutted against the second limiting block 43, the handlebar 10 cannot continue to be rotated, so that the handlebar 10 is prevented from being rotated by 180 degrees to the left or right when turning, thereby preventing children from falling down, which is convenient for children to better learn to ride bicycles.

Further, the second limiting block 43 is provided with two first limiting surfaces 44, and the two first limiting surfaces 44 are symmetrically arranged. An included angle between an extension line from each of the first limiting surfaces 44 to the center of the rotating member 20 and a horizontal line is 30 degrees (an angle α in the figure).

Further, the first limiting block 31 is provided with two second limiting surfaces 32, and the two second limiting surfaces 32 are symmetrically arranged. An included angle between the two second limiting surfaces 32 is 60 degrees (an angle β in the figure).

In the present embodiment, since the included angle between the extension line from the first limiting surface 44 to the center of the rotating member 20 and the horizontal line is 30 degrees, and the included angle between the two second limiting surfaces 32 is 60 degrees, the maximum turning range of the left and right rotation of the handlebar is 120 degrees when the handlebar is turned left and right, which can prevent children from falling down due to the excessive turning range during turning while ensuring turning, so that children can better learn to ride bicycles. By adopting the limiting structure of the bicycle, the limiting structure of the bicycle is simpler and more compact in structure, and the production and assembly of the bicycle are facilitated.

Further, the rotating member 20 is provided with a positioning portion 21, and the first limiting block 31 is abutted against the positioning portion 21.

In the present embodiment, the first limiting block 31 is abutted against the positioning portion 21, and the front fork 30 can be more quickly mounted on the rotating member 20 through the positioning portion 21, thereby facilitating positioning and mounting of the front fork 30.

Further, the limiting structure of the bicycle further includes a front wheel 51, a rear wheel 52, and two auxiliary wheels 53. The front wheel 51 is movably connected to the front fork 30, the rear wheel 52 is movably connected to the frame 40, and the two auxiliary wheels 53 are symmetrically arranged on two sides of the rear wheel 52 and movably connected to the rear wheel 52.

In the present embodiment, the two auxiliary wheels 53 are symmetrically arranged on two sides of the rear wheel 52 and movably connected to the rear wheel 52, so that the bicycle can keep balance, and children are further prevented from falling down in the process of learning to ride bicycles, thereby facilitating children to learn to ride bicycles more.

Further, the limiting structure of the bicycle further includes an adjusting member 61 and a seat 62. One end of the seat 62 is accommodated in the frame 40 and movably connected to the frame 40. The adjusting member 61 is movably mounted on the frame 40. The frame 40 is provided with a groove 45, and the adjusting member 61 shields the groove 45.

In the present embodiment, the adjusting member 61 is loosened to enlarge the groove 45, so that the height of the seat 62 can be conveniently adjusted; and the adjusting member 61 is locked to reduce the groove 45, so that the seat 62 can be fixed to the frame 40.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A limiting structure of a bicycle, comprising: a handlebar, a rotating member, a front fork, and a frame; the frame being provided with a mounting portion; the handlebar being partially accommodated at one end of the mounting portion, and the front fork being partially accommodated at the other end of the mounting portion; the rotating member being accommodated in the mounting portion; two ends of the rotating member being movably connected to the front fork and the handlebar, respectively; an annular movable groove being formed between an inner wall of the mounting portion and the rotating member; the front fork being provided with a first limiting block, and the first limiting block being movably accommodated in the movable groove; the frame further comprising a second limiting block fixedly accommodated in the movable groove.

2. The limiting structure of the bicycle according to claim 1, wherein the second limiting block is provided with two first limiting surfaces, and the two first limiting surfaces are symmetrically arranged; an included angle between an extension line from each of the first limiting surfaces to a center of the rotating member and a horizontal line is 30 degrees.

3. The limiting structure of the bicycle according to claim 1, wherein the first limiting block is provided with two second limiting surfaces, and the two second limiting surfaces are symmetrically arranged; an included angle between the two second limiting surfaces is 60 degrees.

4. The limiting structure of the bicycle according to claim 1, wherein the rotating member is provided with a positioning portion, and the first limiting block is abutted against the positioning portion.

5. The limiting structure of the bicycle according to claim 1, further comprising a front wheel, a rear wheel, and two auxiliary wheels; the front wheel being movably connected to the front fork, the rear wheel being movably connected to the frame, and the two auxiliary wheels being symmetrically arranged on two sides of the rear wheel and movably connected to the rear wheel.

6. The limiting structure of the bicycle according to claim 1, further comprising an adjusting member and a seat; one end of the seat being accommodated in the frame and movably connected to the frame, the adjusting member being movably mounted on the frame; the frame being provided with a groove, and the adjusting member shielding the groove.
